(19) United States
(12) Patent Application Publication
(10) Pub. No.: US 2007/0208823 A1
(43) Pub. Date: Sep. 6, 2007

(54) System and Method for Making a Data Silo to Distribute Electronic Data

(75) Inventors: Marvin Shannon, Pasadena, CA (US); Wesley Boudville, Perth (AU)

Correspondence Address: MARVIN SHANNON, 3579 EAST FOOTHILL BLVD, #328, PASADENA, CA, 91107, US

(73) Assignees: Marvin Shannon, Pasadena, CA (US); Wesley Boudville, Perth (AU)

(21) Appl. No.: 11/307,721

(22) Filed: Feb. 17, 2006

(51) Int. Cl. G06F 15/16

(52) U.S. Cl. 709/217

(57) ABSTRACT

We have a method of making a Web Service and a website, which we call a Silo, that lets a sender upload a file (or directory) of arbitrary size, that she wants distributed electronically to one or more recipients. The uploading can be done via a standard web browser. The Silo associates a token with that file and gives that to the sender. The token is some random bit sequence. The sender can then send that token and the Silo's URL, to her recipients. Who can then use a browser to go to that Silo, present the token, and get the file. A simple usage for sender and recipient. It lets the sender compartmentalize access to various files, and avoids the limitations of using email or ftp to transfer the files. E-commerce can be enabled by having the Silo act as a recognized financial intermediary, and by the sender selling items. With a recipient paying the Silo, who acts as an escrow. The seller can also conduct public or private auctions, using the Silo to host them. We make a Reverse Anonymizer (RA), which is a computer on the Internet that lets two parties connect and interact electronically, where the initiating party does not know the network address of the other party. Optionally, the latter might not also know the address of the former. One or both of the two parties might be a computer program, or a human. The RA mediates messages between the parties. We describe how the RA differs significantly from a reverse proxy server or an Instant Messaging server. The RA can be used to enhance the privacy and security of Internet communications and data transfer.

### TECHNICAL FIELD

This invention relates generally to information delivery and management in a computer network.

### BACKGROUND OF THE INVENTION

Suppose you have a data file on a computer. You want to send it to recipients on other computers, where in general, these computers are somewhere else on the Internet. You know the email addresses of the recipients, and possibly some other network addresses that they might have. (Like Instant Messaging addresses.) You can send the data by non-electronic means, like postal mail, if you know the recipients' physical addresses. But suppose, for whatever reason, you are restricted to some electronic means of transfer.

Also, the file might have sensitive data. In general, you and the recipients do not want others to have access to this file.

One way to send the file is by email. But this has several disadvantages. One is that typically, there are limits on the size of a single email. Often 10 Mb, for example. Plus, even if your computer and a recipient's computer has larger limits than this, it may not be true for intermediate mail relays. And, in general, you have no control over which relays your mail might pass through. Also, suppose you sent a small test message to a recipient, in order to find out the relays it went through. (The recipient could email you the header she got from your message, containing this information.) Then suppose, you somehow found that those relays could indeed handle messages large enough for your file. But whenever you send a message to the same destination, there is no guarantee that it has to go through the same relays. Due to congestion or other problems, a relay might become unavailable, and another relay is used.

So if your file is too large, you might run some special utility program that can split this into smaller files. And you then send each of the latter as a separate email to a recipient. Then, when the recipient gets all these, she can run a similar program to combine the message bodies into a copy of your original file. But this process is problematic for several reasons. On the sender side, there are two assumptions. One is that the necessary utility be present on your machine. And the other is that you are aware of it and can use it properly. Neither is necessarily true. The biggest assumption is the second. You, the sender, may not necessarily be computer adept. The corresponding statements can also be made for the recipient side. This is compounded by the additional difficulty that if you send to several recipients, then they all need to successfully implement their steps.

Now let us suppose that your file is small enough that it can be sent by email. Call your machine Alpha, and one of your recipient's machines Beta. Let the mail relays for a message be R1, . . . , Rn. A copy of one of your emails goes from Alpha to R1 to . . . to Rn to Beta. On each machine, it could be copied without your knowledge. Plus, it might also be modified (a man in the middle attack). The mail protocols cannot detect this, in general. So the more relays, the greater the risk of some rogue sysadmin or malware program doing this. Remember that even if you are confident about the security on Alpha and Beta, you have no say over {R1, . . . ,Rn}. Also, the email is stored as plain text, and also when it is transmitted between relays.

Instead of email, another alternative is using ftp. Indeed, for large files, this is often seen as the only practical method. In general, ftp can enable the transfer of files of up to gigabyte size or more. But ftp has severe problems of its own. Suppose your machine can act as an ftp server. You put your file there. You can then inform your recipients, by email perhaps, of this. But for them to download the file, they must login to your server. This can be done by anonymous ftp, or by non-anonymous accounts. For anonymous ftp, anyone can login. Which may be highly undesirable because unauthorized others can get a copy of your file. Furthermore, anyone who logs in this way can see all the files in the anonymous directory. This may include other files that you do not want even your recipients of this file to access.

Instead, you might make a temporary user account that all the recipients use, and put your file there. Where the file has permissions forbidding that user to delete it. In practice, unless you are a sysadmin, you have to ask your sysadmin to do these steps. Then you need to inform each recipient of 3 items—the username, password and the URL of your ftp server. Suppose all this happens, and your recipients successfully download that file. At some future time, you have another file. You (or your sysadmin) puts it in that directory, and removes the earlier file. The password should be changed. Because when your recipients got your earlier information, it might have also be read by crackers. Or when your recipients downloaded the earlier file, a cracker's network sniffer might have read the username and password. So having changed the password, you have to recontact your recipients with the new information, telling them to get the latest file.

Also, most ftp servers accept a username and password in an open channel. And the uploading or downloading of a file is often also via an open channel. There is a secure channel version, called ftps, but that is not often used.

It should be appreciated that all of this involves many manual steps on your side. Plus, it also assumes that you have an ftp server to which you can put files. In general, this is not true for most users.

A third alternative is to have some company offer disk space that is accessible on the Internet. You can sign up for an account and store files there, where the access is via a browser. Of course, if you could store files, you would normally be able to delete them. The problem now arises in letting your recipients access a particular file. Basically, you have to give them your username and password. Whereupon, any of them could delete that file, or change it, intentionally or otherwise. So too could a cracker who managed to find your username and password, perhaps from the electronic message that you sent containing these, to the recipients. Granted, if the file was changed, then it would have a timestamp set by that company, and this change in time might be used by the recipients to detect if the file was altered, where you tell your recipients in your message about the original timestamp. But you cannot expect all of your recipients to be this observant.

An elaboration to get around the problem in the previous paragraph is for you to be able to define another account, with read-only access to the files you stored. More work for you. Note that “you” may not necessarily be computer-adept.

Another problem arises if you want to sent file A to group Gamma of recipients, and file B to group Rho of recipients. And you do not want Gamma to access B and Rho to access A. You cannot compartmentalize file access inside the same account, at least under most (or all) current operating systems.

The fundamental problem with this approach is that it is inherently single user. It does not scale to two or more users accessing the same account and files.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

We have a method of making a Web Service and a website, which we call a Silo, that lets a sender upload a file (or directory) of arbitrary size, that she wants distributed electronically to one or more recipients. The uploading can be done via a standard web browser. The Silo associates a token with that file and gives that to the sender. The token is some random bit sequence. The sender can then send that token and the Silo's URL, to her recipients. Who can then use a browser to go to that Silo, present the token, and get the file. A simple usage for sender and recipient. It lets the sender compartmentalize access to various files, and avoids the limitations of using email or ftp to transfer the files. E-commerce can be enabled by having the Silo act as a recognized financial intermediary, and by the sender selling items. With a recipient paying the Silo, who acts as an escrow. The seller can also conduct public or private auctions, using the Silo to host them.

We make a Reverse Anonymizer (RA), which is a computer on the Internet that lets two parties connect and interact electronically, where the initiating party does not know the network address of the other party. Optionally, the latter might not also know the address of the former. One or both of the two parties might be a computer program, or a human. The RA mediates messages between the parties. We describe how the RA differs significantly from a reverse proxy server or an Instant Messaging server. The RA can be used to enhance the privacy and security of Internet communications and data transfer.

### BRIEF DESCRIPTION OF THE DRAWINGS

There are no drawings.

### DETAILED DESCRIPTION OF THE PREFERRED EMBODIMENT

What we claim as new and desire to secure by letters patent is set forth in the following claims.

We propose a method that uses a server computer that is on the Internet and accessible by a browser. We call it a Silo. Let Linda be someone who wants to make a file accessible to Hamid and Zoltan. Assume that each has web access and a network address at which he or she can be contacted. Without loss of generality, let this network address be an email address. (An alternative might be a phone number, Instant Messaging id, or SMS address.)

We now give the simplest implementation of our method. Later we discuss extensions to this.

Linda goes to the silo's URL. The page offers two basic functions—sender or recipient. She picks sender. At this page, or a subsequent one, she enters her username and password, if she is an existing user. If she is a new user, then she can join. Typically, she would be required to furnish some type of electronic financial credential, like credit card information. Assume that she has successfully done so, and is now a member, and with a username and password. This login can be preferably done via a secure channel like https.

Linda is now logged into the Silo. She uploads a file from her computer to the Silo, using standard methods provided in the page for file transfer. Such methods can handle large files, of hundreds of megabytes or more.

Optionally, but preferably, she could also upload some metadata about the file. These might be descriptive comments about the contents of the file, or how to use the file, for example. Strictly, she does not need to know anything about the format in which this metadata is stored, because the web upload page would have various fields in which she would enter different types of metadata. But optionally, and preferably, this metadata would be described in XML, because of the intrinsic extensibility of that language. And because it makes it easier if the Silo exposes a Web Service or Application Programming Interface to permit the uploading to be done from a third party program that accesses the Web Service or API.

Optionally, she could restrict the maximum number of downloads of the file. This can help to restrict any downloading by unwanted persons.

Optionally, she can place a restriction on the total download bandwidth, across a set of files that she has uploaded, or will be uploading. If she has many files, this may be an easier overall restriction for her to set, rather than per file.

Optionally, she could require that the downloading be only done to a computer subject to some restrictions, including, but not limited to, one or more of these:

In some IP address range.

Not in some IP address range.

In some domains.

Not in some domains.

In IPs that are in some geographic region.

In IPs that are not in some geographic region.

Optionally, she might require that the downloading be only to a registered recipient. In this case, she might have restrictions on the email address of the recipient, including, but not limited to, one or more of these:

In some domains.

Not in some domains.

If the network address of the recipient is a phone number, then the sender might have restrictions on this, including, but not limited to, one or more of these:

In some countries.

Not in some countries.

In some area codes of some countries.

Not in some area codes of some countries.

If a recipient has both an email address and a phone number, then the sender may optionally impose some combination of the above restrictions.

After this happens, the Silo computes a token (possibly implemented as a random sequence of bits), and checks that it does not already exist in the keys of a hash table, where that table maps from a token to a file and its metadata. If the token already exists as a key, then the Silo repeats this process until it has found a new key that is not in the table. There may be some simple logic here to ensure that it does not go into an infinite loop. But as a practical matter, for a suitably long choice of token length (e.g. more than 120 bits), and a suitably robust random number generator, not many loops should be needed to find a new, unused token.

The Silo then adds the (token, file+metadata) to the hash table, where the token is a key and the file+metadata is the value. The theory of hashing and of hash tables is highly developed, and has been used since the 1960s. (“The Art of Computer Programming” by D Knuth, p. 513, Addison-Wesley, 1998.) Existing hash algorithms have been heavily tested and are considered very robust for this application. Note that our method does not depend on any particular hash algorithm.

When the Silo has found the token for Linda's file, it displays it in a page in the browser, possibly via a secure http connection. Optionally, as an alternative, or in addition to, it could email the token to Linda, if it knows her email address and if she chooses to be informed in this fashion. The email might optionally also have a hyperlink to the Silo, with the token being part of that link, so that the link will point to the file. This might be done as a convenience to Linda, so that she can forward the email to others, as discussed below. (Or the Silo might offer Linda the alternative that it can email the recipients, whose addresses she furnishes to the Silo, the information about the file's token.)

The file (and any metadata) will exist for some period of time in the Silo. It might have a default lifetime. When uploading the file, Linda could also have explicitly set this lifetime, where it could be greater than or less than the default lifetime.

Linda now takes the token of her file and sends it to Hamid and Zoltan. This could be by electronic or non-electronic means. The message might also tell them how long the file will be in the Silo. It might also tell which Silo the file is at, since there could be several Silos.

Hamid now uses his browser to go to the Silo. He is now using it as a recipient. He types the token in an appropriate box and submits it. The Silo gets the token and his IP address. It might apply any constraints that Linda set on this. If it fails, then the Silo returns some error message.

Assume that Hamid satisfies those tests. The Silo checks the token against its hash table. If the token does not exist, then it tells him. Optionally, if the token has expired, then it can tell him this extra piece of information. Optionally, if Linda set a maximum number of downloads, and this has been reached, then the Silo might tell him this, without necessarily identifying Linda in its reply.

But suppose the token exists and none of the other constraints have been triggered. The Silo then proceeds to download the file to Hamid's computer. Zoltan does likewise.

This is an anonymous recipient usage, if Linda did not tell the Silo to impose any constraints on the recipient, like those discussed above. It is very simple for the recipient to perform, and is a “dead drop” of a file. Another variant is for Hamid or Zoltan to first login to the Silo, before downloading.

The Silo is fundamentally different from a search engine, and much simpler. Though the search engine uses hash tables, it first has to spider the web to get its data. The Silo gets its data sent to it. Which reduces one type of computational requirement. Plus, and more importantly, the Silo's “search” query (the hash lookup) essentially gives one result—does the hash exist or not? And if the hash exists, then get the associated file and any associated metadata. A search engine often finds many results for a query. And much of the search complexity arises in ranking those results. Basically, the Silo is about data distribution, not searching. [Though see later remarks about how we can enable searching.]

Extensions

We discussed how Linda could upload a file. She could also upload a directory, that contains files and possibly subdirectories recursively down to some level. In what follows, when we refer to a file, we implicitly include the case of a directory.

The metadata could have an optional field, call it Privacy. Whose value is true by default. So that a recipient needs the token in order to find the file, as already discussed. But if the sender explicitly sets it false, then it means that the Silo can let a user search its site for that file's metadata, or subsets thereof, without knowing the token.

If the Privacy field is implemented, then the Silo might let the sender change this setting for her file, after it has already been uploaded.

The Privacy field might also be implemented as a non-Boolean. It can take on more values than true or false. There might be a value which is the name of a group of users (potential recipients). Or which is a set of names of such groups. Here, the sender might define each group name, and the constituents of such a group. It might be by explicit email addresses of each user. Or it might be by wildcards. For example, “*@college.edu”, to include all users at that domain. A group might contain other groups. Then, a registered recipient who is a member of such a group can search for the file, without knowing the token. In this context, if a name has a wildcard, then a minus sign in front of it can be taken as meaning that none are allowed from that domain. Also, if a group has an entry with a name of another group, then a minus sign in front of the latter means that no members of that group can search for the file.

Optionally, the Silo lets Linda specify the token she wishes to use. Or some subset of bits within the token. Suppose the token is 160 bits long. She might specify the bit pattern within the first 120 bits. Then, the Silo gets her token and file and metadata. If she has specified all the bits, then the Silo sees if it already has that as a key. If so, it accepts the token, and makes a new entry in its hash table. Otherwise, it does the usual process of generating a new random token, and returns that. But if Linda has specified the first 120 bits, then the Silo tries to make a new token, using the remaining 40 bits as degrees of freedom in doing so. In the vast majority of cases, it will be successful, and will return the actual token, which will have the first 120 bits that Linda specified. Otherwise, it will make a new random token and a new table entry, and send her the token. Clearly, the latter case should be very rare.

The metadata for a file can have fields with tokens of other files. These files could be for that sender. So for example, if you (a recipient) are interested in this file, you might also be interested in other files.

Optionally, the Silo lets the sender list tokens of other senders' public files. These are files with Privacy=false.

Optionally, the Silo lets the sender list tokens of other senders' private files. Presumably, the sender has obtained these tokens from the other senders, with their knowledge and consent. Related to this, a sender might have a metadata flag that prohibits any other sender from listing one of its tokens for a private file.

Optionally, the Silo can change or add to the metadata of any file. For example, it might add tokens to point to other senders' public files, that it deems might be related to this file. It might use knowledge that the sender of this file did not have, or perhaps had access to, but did not use. This lets the Silo offer more services to a possible recipient.

Also, one important change it could add might be a classification of a file, that points to other public files in that grouping, across all senders.

Optionally, the Silo lets Linda see a listing of all her unexpired and expired files. The expired files might be listed up to some maximum time after they have expired. The Silo might show statistics about each file, such as the current number of downloads, and possibly the timestamp of each download and the IP address of the recipient. It may also show summary statistics based on such data.

Related to this, the Silo can compute similar statistics over all its senders' files, to find which types of files are the most popular for downloading, and which types of ads get clicked on the most, for example. Optionally, the Silo can make such summaries available to visitors, whether they are potential senders or recipients. So that they can get an idea of what is most popular on the Silo.

The Silo can charge Linda based on one or more of several factors, including but not limited to the following:

The size of the file or directory she uploaded.

The length of time she wants it to exist.

The maximum number of downloads or the maximum download bandwidth. The latter might be with respect to this file, or across all files that she has sent to the Silo.

The number or type of constraints on the recipient that she imposed.

The Silo can let Linda remove her file, before it has expired, or before the maximum number of downloads has been done, or before the maximum download bandwidth has been consumed. It might charge her for this early removal ability.

Suppose a file has been downloaded for a maximum number of times, and is now unavailable for download. Or perhaps it is unavailable because the total amount of downloaded bandwidth has exceeded a limit Linda imposed. The Silo can keep a count of future requests for this file, that go unsatisfied. Periodically, it can send her this information. So that she can gauge the amount of unfilled demand, per file. It helps her decide whether to pay for more downloads.

Above, we briefly mentioned how there could be several Silos. These could be independent of each other. Much like the way different companies run their own web servers. Some Silos might specialize in a particular region or country, or industry. The functionality of a Silo might be included in an industry portal, for example. So that a Silo does not have to be a standalone website devoted just to the role described here.

The recipient might see ads. Especially if she is anonymous, and hence not paying anything for the service. The ads are a possible revenue source for the Silo. If the recipient is not anonymous, there might be fewer or no ads.

A special case of the Silo using a token is where the token is a function of the input file, and possibly also of the metadata. For example, the token might be a hash of the file, or a hash of the file+metadata.

Separately from whether or not the actions in the previous paragraph are done, the Silo might make a hash of the file. By doing this for all the files, it can find which files are the same. This can be used to optimize storage, by only retaining one physical copy of a file.

The Silo could act as a common carrier, like an email provider, so that it is not responsible for the content that its users upload. Under its terms of agreement with its users, they agree not to use it for any illegal act. And the Silo can put in processes to act upon complaints by governments or copyright holders.

Suppose a sender uploads a directory. If a recipient presents the token for this directory, and satisfies any other constraints, then the Silo can return a view of the directory that essentially acts as either a micro-web server or as an ftp server interface. Where the root directory is that directory. This lets the sender offer structured access to her data in a way that may be familiar to the recipients. It would be a simple modification of an existing web or ftp server to enable this.

An elaboration is for the Silo to offer an abstract data view of the directory's contents. The syntax of this abstraction might be defined by the Silo as a Web Service or API such that the sender might be able to customize her data within that viewpoint.

We have described the logging in by the sender and the uploading of a file by the sender, using https as a preferred protocol. But other protocols, including peer-to-peer protocols, are also possible. Though for any such that are used, it is still preferred that they maintain a secure channel. Similar comments are applicable for the recipient logging in or downloading a file.

We have described how the recipient uses a browser to download the file. But the Silo can also publish an API or Web Service such that other programs might be able to access its data.

The Silo can publish a Web Service such that on a sender/seller's website, where it is describing an item for sale, via the Silo, it can easily program a link or button that goes to the Silo and to the item under consideration.

Also, consider a software product that is sold under a license, that might have to be paid annually, say. It can have an option that lets the user renew the license, by using the above Web Service to go to the Silo's page for the product, where the payment can be made. The product can also have an option that lets the user easily buy another copy of it. The option uses the Web Service to go to the Silo's product page, where this purchase can be done.

The Silo can be searched for metadata for products that have Privacy=false. This searching can be done via manual command at one of the Silo's web pages. Or it might be done programmatically, via a Web Service exposed by the Silo for this purpose. Specifically, the Silo might be searched for a particular version of a product, or, an important special case, the latest version of a product. Another important case is if the item is a patch for some product or operating system. If a desired item is found, the user can download it manually as described earlier. This can be considered a “pull” of the product. But the Silo can also let a user register with it, specifying for example that she wants the latest version of a product. Then, when the Silo obtains such an item, it transmits a copy to the user's computer, via a daemon or Web Service or other listening program that the user has running, for this purpose. This can be considered a “push” of the product.

It is also possible to have two levels of Silos. Possibly, this might be when a sender has a very large file that is beyond the capacity of some Silos to hold. Imagine a “Top Silo”. Its main purpose is to take a file uploaded to it, split it into several portions, and send each portion to another Silo. Hence, the Top Silo returns to the sender a vector of items, where each item is a doublet (silo, token), that points to a given Silo and the token refers to the file fragment on that Silo. (We imagine that the sender is already a member of all these Silos.) It is not necessary, though it is possible, for the Top Silo to hold the entire file at one time. As part of the upload process to it, it might ascertain the size of the incoming file, and thence effectively hold only a single fragment at a time, which it then sends to another Silo, before getting the next fragment from the sender's computer.

As an alternative to returning a vector {(silo, token)} to the sender, the Top Silo might return only a token, Gamma, which is used only by it. Then, a recipient gets (Top Silo, Gamma), and can then present Gamma to Top Silo. It has a specialized ability to map from Gamma to {(silo, token)}, and then to query those Silos and assemble and download the file to the recipient.

It is possible for a sender to ask the Silo to allocate a certain amount of storage space for a file, and return a token to the sender that points to this space. Then, the sender can send the token to a recipient, asking her to upload a desired file. The recipient goes to the Silo, presents the token, and gets a page, wherein she can upload that file. Optionally, but preferably, the sender pays the Silo for this service. After the uploading is done, the Silo might send a message to the sender, informing her of this, so that she can visit the Silo and get the file.

Optionally, the Silo might have an API such that the sender has a process or daemon running on her computer, such that after the recipient uploads the file to the Silo, it then copies the file to the sender's computer, using that process. Optionally, the Silo can start this while it is still getting the file from the recipient.

In the above, we have chosen the example of the computer network to be the Internet. Hence, we referred to the IP (Internet Protocol) address of a computer, or a URL. But note that our method in general can be applied to any type of computer network, that uses any kind of addressing method for accessing its nodes.

Revenue Models

Above, we have briefly discussed various revenue models for the Silo. Here we discuss other possible sources of revenue.

When the sender sets up her account, she can be asked to give details about the types of files she will be uploading, and about the possible interests of those who might be downloading her files. Likewise, when she uploads a given file, there is optional metadata she can furnish for it, with specific information about it. The Silo can use both types of details to help it decide what types of ads to show a recipient.

If a recipient logs in, then the Silo can use what information it knows about her, to help choose suitable ads. This information can include, but is not limited to, the following:

What the recipient described about herself when she set up her account.

The types of ads that she may have previously clicked on.

The types of files that she may have previously downloaded.

The Silo can combine any sender and recipient information to also help decide what ads to show. For example, suppose the sender came from an IP address in Korea. To the Silo, this might increase the probability that an ad should be in Korean. If a recipient, registered or anonymous, is coming from a Korean IP address, then the probability might be increased even more.

The Silo can also inspect the file that was uploaded. If it is in a common format for a text document, like Rich Text Format, or Microsoft Word, for example, then the Silo may look further in the file to see if it specifies a font or language. From that, it might be able to deduce hints as to what language ads to present to the recipient. Some fonts are alphabet fonts, and sometimes that alphabet might map to only one or a few languages which use it. For example, an Arabic font suggests that the corresponding language is Arabic.

The Silo can also track for each sender, how much ad revenue her files generated, and other related information, like the percentage of click throughs on those ads shown to her recipients. Strictly for itself, the Silo can track the most popular files, using this metric of ad revenue, as opposed to a simple count of downloads. But it can also share some portion of this information with the sender. So that if, for example, the revenue exceeds some threshold, then the sender gets a rebate on her fees. Or even that the Silo makes a net payment to the sender, if sufficient revenue is generated. This aligns the interests of the Silo and the sender. It gives the sender incentive to supply files that will be popular, and to furnish accurate metadata about these files.

Thus far, we have discussed situations where the sender offers files freely. This might include contexts where the sender is a business that is outsourcing the downloading of patches for its software, say, to the Silo. But, more generally, the sender might also sell its products via the Silo.

Where, optionally but preferably, the Silo acts as the financial intermediary.

For example, the sender might have her own company website, describing her products. Someone visiting the website who is interested in a product can click on a button, taking her to the Silo, to a page showing metadata about that product, including the price. The buyer can then give her credit card information, say, to the Silo, who will make the appropriate debit. If this clears, then the Silo can download the file to the buyer. This file might be the product itself, like software. Possibly, once the file is obtained by the buyer, she might have to contact the seller directly for some key to run the software. These are product-specific details that the Silo need not be involved in.

At some later time, the Silo can transfer the funds to the sender, minus some commission.

Why does the seller need the Silo, who charges a commission? Because not all small companies, or individuals running their own businesses, can directly process a credit card number. To be able to do so is costly, in and of itself, and not all small businesses can qualify. Also, a small business with little name recognition might encounter resistance from potential customers, who might be reluctant to reveal their credit card numbers, or other financial details. This is exacerbated by the fake “commercial” websites being set up by phishers, precisely to induce unwary visitors to do so.

The Silo can play an important role for a small business. By acting as a known “reputation service” (“Systems and Method for the Management and Uses of Persona Identification and Reputation in Electronic Communications”, U.S. Provisional Patent No. 60/521,338, filed Apr. 3, 2004 or the corresponding U.S. RPA 10/907,239 filed Mar. 24, 2005), to which a buyer can confidently interact financially, it can help broker transactions that might not otherwise happen. Also, this lets the seller/sender outsource the e-commerce details. Which might not a core competence of the seller. The Silo has expertise in running a secure e-commerce website.

The sender might also offer to pay the recipient for downloading a file. For example, if the sender is developing a software prototype, she might find some users willing to test it, for a fee. She can instruct the Silo, and pass funds to it, to do this, when a recipient logs in. Then she can send tokens to those users she has found by some other means, to do so.

Above, we discussed how the downloaded item might be the product itself. But it could also be a reference to some hardware, or other material object. So that when the recipient gets the downloaded file, she might have to follow instructions in it, for obtaining that object.

The Silo might also let the sender specify that none of its recipients see ads, even if they are anonymous. Or, the sender may be able to limit the number of types of such ads. For the latter, it might be because a sender does not want a competitor's ads to appear. Whereas, to such a competitor, such ads might be highly desirable, because the recipient might be inclined towards buying any instance of that product type. The Silo could charge the sender for such choices. For blocking ads from particular companies, the Silo might let the sender and such companies compete (e.g. bid) for the sender to be able to suppress those companies' ads.

For registered recipients, the Silo might let them, within some time interval after they have downloaded a file, give feedback about that file, and hence about the sender. Possibly, the Silo might also permit this for anonymous recipients. Where it could have methods to prevent such a recipient from voting more than once. Similarly, in such a time interval, the sender/seller might be able to give feedback about the recipient/buyer. In such a case, because the Silo handled payment from the buyer, the feedback probably is unlikely to involve discussions of payment. But instead possibly of such issues as how much help the seller needed in installing the item.

The file can be empty or irrelevant. That is, there is nothing to download, or what is downloaded might have no intrinsic bearing on the transaction. Because the sender might be selling (or have sold) her labor, or is asking for donations. For the latter, imagine a nonprofit organization that solicits such donations, and uses the Silo to handle the collection. For the former, imagine the sender having worked for the recipient, and both agree to use the Silo in order for the sender to get paid.

Here, we described how the recipient pays the sender. The reverse is also possible, if, say, the recipient worked for the sender. In this case, the sender can tell the Silo that only one “download” of funds is possible for an “item”. The item in this case is really just the token. Then the sender sends the token to the recipient. Who can go to the Silo and present it once, in order to get funds.

The Silo might hold funds for its users, be they senders or recipients. If so, it might offer some standard banking features. Including possibly having the funds be insured, and having the Silo being regulated by the appropriate government bodies.

In the above, we described the use of credit cards with the Silo. Other types of electronic funds transfer interactions are also possible, including wire transfers to and from a user's bank account.

The Silo can also enable auctions. Suppose a recipient gets a token for a product from a sender and uses it at the Silo. Then, instead of seeing a download page, the Silo presents a page with metadata on the product, and a place where she can type in a bid. The page might also show feedback information on the sender, based on previous transactions mediated by the Silo. These could include both sales and auctions of the sender. Optionally, the page does not show any other current bids on the product. The recipient submits her bid. Then, at some later time, when the auction is closed, the recipient with the highest bid is informed. She can then go to the Silo to make her payment and get the product.

If the page did not show competing bids, then the Silo has enabled a sealed bid auction. Whereas, if other bids were shown, then this might be a standard English auction. It should be appreciated the Silo might also enable other types of auctions, like Dutch, Japanese and Yankee auctions. (“Internet Marketplaces: The Law of Auctions and Exchanges Online” by Ramberg and Kuner, Oxford University Press, 2003.)

An auction can be private, and is, by default, when the metadata flag Privacy=true. This is equivalent to an invitation-only auction. Where the only way to participate is to be informed by the sender/seller of the auction's token. However, when Privacy=false, the auction is public. Any user can use the Silo to search for various entries in the metadata for desired auctions.

Advantages

Our method has several advantages over earlier methods.

It can handle arbitrarily large files, unlike email.

It is less vulnerable to rogue operators or malware than using email which goes through a variable set of relays. Plus, email is transmitted as plain text, so that it is vulnerable to sniffing on any channel that it passes through. However, the uploading of a file by a sender, and the downloading by a recipient can be done via https, to block any sniffing.

Operationally, it is simpler for both the sender and recipient to use, than, for example, fragmenting a large file into pieces that can fit into email. Or for the sender, or, more plausibly, a sysadmin, to have to set up customized ftp accounts for the recipients. In our method, the only manual operations are those done by the sender and recipient. The Silo's normal operational mode can be fully automated.

The sender and recipients only need browser access to the Internet. The sender does not need write access to an ftp server. Nor do those browsers need any special extensions or plug-ins.

Usage by recipients is compartmentalized. The sender can be offering different files to different groups of recipients, and no group has access to the others' files. This is also important in view of a common phenomenon of mobile users. Imagine a recipient who has some computer writable media, into which she want to download a file from the sender. She has already gotten the token. She goes to some cybercafe or public library with Internet access. She uses a browser to go to a Silo, where she enters the token, and then downloads the file into her media, which she inserted into the computer. In such environments, there is a real risk of gadgets like keyboard loggers being placed, that pick up all key strokes. Or for viruses on that computer or in the local network, that record events for a cracker to later use. Suppose the token and the Silo's address was copied. Perhaps even the file as it was downloaded. A worst case scenario.

A variant of this is if she takes her mobile computer to a cafe, say, and uses a wireless means offered by that cafe to connect to the Internet. Here, there might also be wireless sniffers.

But even here, knowing the token and the Silo does not give the cracker access to any other files on the Silo. There is an inherent compartmentalization in the operation of the Silo that acts to firewall any infiltration. In contrast to various other data storage services that have an all or nothing access mode.

Plus, suppose the cracker was not able to copy the file as it was downloaded, but just found the token and Silo. If the sender set some restriction like a maximum number of downloads, and that was reached when the recipient downloaded, then the file is not accessible to the cracker.

In the above scenario, it might be noted that the upload of the token to the Silo might be done by https, and possibly also for the download. So that any sniffer might not get the token. But a keyboard logger reads directly the key strokes, and can thus do so.

Our method lets individuals or companies easily distribute their data. Without having to buy large bandwidth access to the Internet, and having their own computers directly serve the data to recipients. Our method is a modular outsourcing of data distribution. This is especially germane if a company expects a temporary upsurge in demand for a particular file. It might be a software patch, for example. It may be costly for the company to buy a lot of bandwidth to accommodate that peak demand, when it will be mostly unused later. Whereas a Silo can purchase bandwidth in larger quantities, and get bulk rates. Plus, because it has many customers that are independent of each other, it can expect its total usage to be a smooth average of individual demands.

Because under our optional but preferred implementation, a recipient cannot alter a file, then the Silo can be easily replicated or mirrored or physically distributed in some fashion, to optimize performance.

Reverse Anonymizer

Sometimes in communications across the Internet, a user wants to hide her network location (IP address), when she visits another location. Typically, she can use a proxy server or anonymizer. The anonymizer might be accessed in a browser. She goes to that anonymizer's web page. In it, there might be a box where she can type the URL of a destination. Then, the anonymizer goes there. In the subsequent interaction between her and the destination, the destination only knows that its interlocutor is the anonymizer, and not her address.

But there may also be times when a destination wants to conceal its address from somebody or some program that visits it. This immediately poses the question of how that entity can find it?

Our method describes a server, which we call a Reverse Anonymizer (RA), that sits between a user and a destination, in such a way that the user does not know the destination's address. The RA is an extension of the Silo that we described above. In what follows, we shall use the terms RA and Silo interchangeably.

Let Linda be a sender, with a network address, which we shall take to be an email address, without loss of generality. She wants another user, Hamid, to communicate with her computer, Kappa. Hamid also has an email address, and both know each other's address. Note that Linda's email address is not at the domain or IP address of Kappa, in general. Linda might have an email account at a major ISP, for example, and so this is independent of Kappa's address. Linda does not want Hamid to know Kappa's address.

Linda does the following. She goes to the Silo, using a browser, perhaps, and asks for a token. Unlike when she might be uploading a file, in this case she indicates, possibly through a choice of options on the Silo's web page, that she wants to use the Silo in its role as an RA. She enters Kappa's address. The Silo records this, and returns a token to her. She then emails the doublet (silo, token) to Hamid, where “silo” is the address of the Silo.

Optionally, but preferably, the Silo charges her for this.

Optionally, but preferably, the Silo lets Linda impose various restrictions on Hamid, when he tries to communicate with the Silo. These include, but are not limited to, one or more of these conditions on Hamid's network address, when he does so:

In some IP address range.

Not in some IP address range.

In some domains.

Not in some domains.

In IPs that are in some geographic region.

In IPs that are not in some geographic region.

Hamid takes the (silo, token) and goes to Silo. He presents the token. Assume that the token is valid. Assume also that Hamid satisfies any restrictions that Linda might have imposed on him or on where he connects from.

The Silo uses the token to look up in its database. It finds Kappa, and tries to open a connection to it. If this fails, the Silo tells Hamid that the connection cannot be currently made, and he should perhaps try later. But suppose the connection is made. Then the Silo, through a web page that it makes for Hamid, lets him access this connection. It takes the input he makes and sends to Kappa. And it takes Kappa's output and sends to the page that Hamid is interacting with. This is the basic mode of operation of the Reverse Anonymizer.

An extension is that the RA exposes an Application Programming Interface (API) or Web Service such that the presentation of the token by Hamid is actually done by a program running on his computer, to this API or Web Service, instead of to a web page. Hence, Hamid is not restricted to a manual http, https, ftp or ftps web-type connection to the RA. Though optionally, the RA might let Linda impose such a restriction.

Optionally, one or both of the RA's channels to Hamid and Kappa are in a secure fashion, to combat evesdropping. For example, the channel to Kappa might be in a Virtual Private Net.

Assume that the process on Kappa is an interactive terminal. So that Hamid has to login, typically. If so, assume that he is successful in doing so. Linda might configure the process so that Hamid is restricted as to what commands he can run on Kappa. He might also be restricted as to what directories he can access, and what files, if any, he can copy to or from Kappa.

RAs might be cascaded. So that Hamid connects to RA A, say. The token presented to it may tell A to make a connection to RA B. Etc. Up to some RA N, which then connects to Kappa. Linda might have explicitly set up this chain, possibly for extra protection of Kappa's privacy. At the cost of greater latency, of course. As well as any possible fees imposed by each RA.

Optionally, we could have an implementation such that when RA A is making a connection to RA B, the syntax for this is the same as connecting from RA to Kappa. That is, each RA and Kappa implement the same interface for connecting to an RA. This can make for a simpler, more modular design.

The RA could let Linda change Kappa's address, if she logs in and presents the token. This lets her dynamically change where on the network her machine (perhaps she has several) will be, to interact with Hamid. More robust, if a given machine becomes unavailable.

If we have cascading RAs, and assuming that RA A can tell that it is connected to RA B, then A might choose not to tell Hamid that it is connected to another RA, instead of directly to Kappa. This might be offered as a configuration option to Linda.

Extensions

When Linda gave the address of Kappa to the RA, she might instead give the addresses of several computers, K1 . . . Kn. This might be for the special case where the programs that are running on those machines essentially just accept data. So when Hamid, or a program on his computer, connects to the RA, he is uploading data that gets distributed in a fan-out or multicast fashion. Where the RA handles the low level details of the fan-out.

Alternatively, Hamid might have a program on his computer that essentially accepts data. And the programs on K1 . . . Kn essentially output data. So when Hamid's program connects to the RA with the token, it gets data in a fan-in fashion. With the RA handling the low level details of combining the input data feeds from K1 . . . Kn. Above, we had discussed a cascading chain of RAs, where choice and order of RAs was determined by Linda. An alternative is for the Linda to contact one RA, Alpha. Then either under a directive from her, or under its own initiative, it finds an ordered list of RAs {R1, . . . ,Rm}, that describes the route that messages between Linda and Hamid will take. Here, R1 connects to Linda and Rm connects to Hamid. Note that in general, R1!=Alpha.

When Linda contacts Alpha, she might give it a parameter of the number of RAs she wants in the path to Hamid.

There could be different types of RAs. One type might be a scheduler, like Alpha, that puts together a route of RAs. It might try to perform a load balancing across RAs. Another type of RA might essentially be a directory service, that other RAs register with, and give details about themselves. Then, a scheduler might consult the directory for available RAs.

We could have a set (“cloud”) of RAs, which act together, in part to offer such services to outside users. With possibly some RAs being on the perimeter of the cloud, and interacting with the outside network. The interior RAs might optionally be inaccessible from the outside. The perimeter RAs route messages through the interior RAs.

Linda could specify, or Alpha might decide, that the choice of a route of RAs be random in several senses. The route could be be randomly chosen, compared to any previous choices made by Alpha, for Linda or for other users. But once a route is chosen, the messages between her and Hamid travel deterministically along it.

Alternatively, Alpha might choose a set of RAs, and during the interaction of Linda and Hamid, messages might travel along different routes within that set, with the routes picked in some random fashion. This method could offer a maximal variable latency that makes it harder for an evesdropper to find information about the parties.

Differences

There are significant differences between our RA and the two closest functional entities that currently exist on the Internet. These are a reverse proxy server and Instant Messaging.

A reverse proxy server (RPS) is a server that is connected to a private subnet and various web content servers therein. The RPS is also connected to the Internet. It accepts web requests from users on the Internet. It sends these to the various web content servers, which are usually not accessible directly from the Internet. These servers reply to the RPS with some pages, which the RPS then sends back to the users. The differences compared to our RA include:

The RPS and the web content servers are all owned by the same company or organization, For an RA, the servers can be owned by different organizations.

The web content servers are in a private subnet. For an RA, in general, there is no private subnet.

The web content servers serve web data, using the protocols http, https, and occasionally ftp, ftps. In general, an RA can use an arbitrary protocol.

A web content server serves content. A server computer connected to an RA need not do so. It may actually be accepting content from a user (Hamid).

While a user of an RPS might not know of the existence of any web content servers, because he knows the address of the RPS, and this and those servers belong to the same organization, then he knows the address of the content provider. An RPS does not let an organization hide its address.

Instant Messaging (IM) has emerged as a popular means for individuals to communicate electronically. Consider a typical IM server. When a user connects to the server for a session, she can use a temporary handle (id), or a long-standing handle that she has used in the past. The ids of all currently logged in users might be shown by the server to each user. So that a user can see if there is someone else she wants to talk to. The differences compared to our RA include:

In using an RA and a token, Linda can associate detailed restrictions with the token, where the restrictions apply to whoever (Hamid) uses the token. Often with an IM server, there is no such restriction. Beyond possibly a buddy list and a black list.

By default, the RA's tokens are private. That is, someone cannot login to the RA and see a listing of such tokens. In contrast, an IM server has the opposite default policy with its handles.

IM is a modality of primarily exchanging text information, with possibly some audio and video. The data is geared towards being viewed by the perception senses of a human. The main, preferred usage of IM is where both parties are humans. There is a minor usage where one party is a “bot” (a computer program). But this usage is very commonly considered by most IM users to be spamming. So much so that an IM server might have measures in place to try to prevent such bots from using it. By contrast, our RA enables the interchange of arbitrary data, some or most of which whose meaning could perhaps be best “perceived” by computer programs. Specifically, both parties using an RA could be programs.

User Profiles

Some websites have, or wish to have, information about people who visit them. A website can gather this information in various ways. For example, it might ask that a user voluntarily registers, and in doing so, answers several questions about herself. It might make this registration mandatory. Separately, it might track the user's browsing activity through the website's pages, in order to garner some information about her interests. It might associate this with her username, if she has one at the website, or with her IP address. So note that the user profiling can be by one or both of explicit and implicit data furnished by her.

A website might do this in order to offer more relevant results to her, if it is a search engine, as one important example. Such information about the user is contextual data that can be used to refine the search results. But there is an ongoing problem with such profiling. It is most pronounced when the website is a search engine. In what follows, we consider this case, though our analysis is also germane to other types of websites.

The user profiling is sometimes known as personalization. Typically, a user wants this profiling, because it improves the usefulness of the search engine to her. Hence, it is also desirable to the website, because it might then be able to serve up more relevant ads, for example, and increase the probability that they are picked by her. But the personalization can also lead to a loss of privacy. One way to avoid this is for her to use an anonymizer to access the website. But this can restrict any personalization benefits to only those that the website can infer during that particular session. Whereas the earlier personalization is information that the website can accrue for her over many sessions. Currently, there is no way to resolve this issue. (Cf. “Seeking Better Web Searches”, Scientific American, February 2005.)

In our Persona Provisional, we offered a method whereby the user can store her profile (which we termed a persona) on her machine. She then uses an agent (a software program) on the machine to transmit the persona, or a subset, to the website, where it is assumed that the latter has an API or Web Service to enable this. Only sending a subset gives her some control over her privacy.

Here, we offer another method. The website can store her profile, without necessarily having her agent transmit it. It associates the profile with a token, via the use of a hashtable, as discussed earlier. She is given this token. This might be via the display of the token in a page, and she then has to manually copy it into her electronic or manual records. Or, she might have a program on her computer that can receive the token from a counterpart program on the website.

Optionally, but preferably, the token cannot be used to deduce anything else about her. For example, the token should not be one of her email addresses. When she next accesses the website, she presents the token, which the website then uses to retrieve her profile. This presentation of the token might be via a box, in which she manually types it. Or the website might have an API or Web Service, and she might have a program, like a plug-in on her browser, that could programmatically access it and present the token.

The website might also let her ask it to make other tokens, that point to her profile. She can then send these to other users, to let them use her profile while on the website. Optionally, but preferably, these are read-only, in that those users cannot change the profile. Optionally, another user might be able to copy her profile.

A variant is that the original user might be able to review her profile on the website, and select a subset of it, instead of the entire profile, to disseminate to others in the above manner.

One issue is that if she is often at one IP address, and goes from there to the website, then the website can associate her profile with the address. She can use a conventional anonymizer to go to the website. There, she can manually type her token, to use her profile. But, this can also be done programmatically, through a simple extension of an anonymizer. Now, it has two programmatic interfaces, perhaps implemented via Web Services. One interface is to its user's computer, so that a program on the latter can send a token to it. Another interface connects to the website's programmatic interface, to pass that token to it.

What is claimed is:

1. A method of a computer (“Silo”) that lets a user upload a file and optional metadata, to be downloaded by others, where the Silo associates a “token” (bit sequence) with that file and metadata, and sends the token to the user, who can then send copies of the token to others, where a recipient of the token can present it electronically to the Silo, which then makes available the file and optional metadata for downloading.

2. A method of using claim 1, where the token is randomly chosen.

3. A method of using claim 1, where the token is a function of the file and optional metadata.

4. A method of using claim 3, where the function is a hash function.

5. A method of using claim 1, where the recipient is required to register with the Silo, possibly including furnishing an electronic address for the recipient.

6. A method of using claim 1, where the user can place restrictions on the maximum number of downloads of the file, across all recipients, or per recipient.

7. A method of using claim 1, where the user can place restrictions on the network addresses or geographic locations of the recipients.

8. A method of using claim 1, where instead of the user uploading a file, space is allocated on the Silo, and a token is made for that space, such that a recipient with the token can upload a file to the Silo.

9. A method of using claim 1, where the Silo lets a visitor search metadata uploaded by some or all of its users.

10. A method of using claim 1, where the uploaded “file” might be a directory, containing files and subdirectories to arbitrary depth.

11. A method of using claim 1, where the Silo mediates an auction, where the uploaded file has information about a good or service for sale, and a recipient/bidder needs to present the token to the Silo, in order to see what is offered and to make a bid.

12. A method of using claim 11, where the Silo accepts payment from a successful bidder and remits this, minus some commission, to the seller.

13. A method of using claim 1, where the Silo mediates a transaction, where the recipient presents the token, in order to make or get a payment.

14. A method of using claim 13, where the payment to or from the recipient is from or to the Silo.

15. A method of a computer (“Reverse Anonymizer” or “RA”) acting as a known intermediary between two users (Alpha and Beta), letting them communicate without revealing their network addresses to each other, by the RA issuing a token to Alpha who forwards this and the RA's address to Beta via another channel, and Alpha and Beta use this to link to the RA, which then relays messages between them.
